(19) United States
(12) Patent Application Publication
(10) Pub. No.: US 2005/0093848 A1
(43) Pub. Date: May 5, 2005

(54) Passive addressed matrix display having a plurality of luminescent picture elements and preventing charging/decharging of non-selected picture elements

(76) Inventors: Adrianus Sempel, Eindhoven (NL); Andrea Giraldo, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/501,168

(22) PCT Filed: Jan. 10, 2003
(86) PCT No.: PCT/IB03/00047

(30) Foreign Application Priority Data
Jan. 15, 2002 (EP) 02075148.3
Sep. 19, 2002 (EP) 02078879.0

(51) Int. Cl. G09G 5/00

(52) U.S. Cl. 345/204; 345/30

(57) ABSTRACT

The invention relates to a passive addressed matrix display having a plurality of luminescent picture elements. Driving circuitry having means for selecting rows of pixel elements and means for driving pixels in a row is provided. A de-coupling means is connected to each picture element for preventing said picture element from charging/decharging when it is in a non-select state and a simultaneously driven picture element is in a select state.

The invention relates to a passive addressed matrix display having a plurality of luminescent picture elements arranged in the matrix, a plurality of address buses arranged in rows of the matrix and supplied with a select signal having a low signal level and a high non-select signal level, and a plurality of data buses orthogonal to the address buses, each of said luminescent picture elements comprising a luminescent layer between a first and a second display electrode.

A problem of the above passive addressed matrix arrangement is that unwanted current can flow on the non-selected, reverse-biased, picture elements, whereby the non-selected pixels are charged and discharged without use. This leads to high peak currents during the data bus on switching transients and extra power loss.

This situation is particularly critical in polymer-LED and organic-LED displays, in which the LED layers have a comparatively large capacitance. This is caused by the fact that the LED layers are very thin (of the order of 10-500 nm). Especially in the case of larger displays, the capacitance hampers passive matrix operation, as the displacement currents become too large in comparison with the currents used to generate light in the LEDs.

It is an object of the present invention to overcome the above-mentioned problem and to reduce the capacitive power losses.

This and other objects are achieved by a display of the type mentioned in the opening paragraph, which is characterized in that each luminescent picture element is combined with a de-coupling means connected between a respective one of the first and second display electrodes and a respective one of the address buses and the data buses, and in series with the picture element, for preventing said picture element from charging/discharging when it is in the non-select state and another picture element is in the select state.

By incorporating of the inventive de-coupling means, any unwanted charging/discharging of non-selected picture elements can be prevented.

In a special case, it is avoided to allow a discharge current in the pixel diode reverse direction.

For the de-coupling function, an active switch which is electrically controllable (e.g. by a row signal), like an electromechanical switch, may be used, but preferably a passive de-coupling means is used which does not need a control signal.

The passive de-coupling means may advantageously be in the form of a (Schottky) diode appropriately arranged between the respective bus and a display electrode. The Schottky diode can be implemented as a layer combination comprising a metal layer and a semiconducting polymer layer. The semiconducting polymer layer for the Schottky diode may advantageously have the same composition as the luminescent layers of the picture elements. The diode can be arranged on the anode side or on the cathode side of the LED pixel.

The invention is applicable to common anode and common cathode addressing, voltage-driven and current-driven addressing and can advantageously be applied using micro-display technology, where the display is directly manufactured on a (mono) Si chip.

In all cases, the problem of a bright column with a shorter pixel is avoided.

In conventional passive addressing, it is not necessary to have a de-coupling switching function in series with a pixel. In fact, it is unnatural to do so. Consequently, passive addressed emissive matrix displays with series diodes are unknown up to now.

The combination of a switch in series with a pixel element is well known in active addressed matrix displays; in fact, it is fundamental. In active addressing, a pixel is switched on at a row pulse, and is kept active for at least one frame time, until a subsequent row pulse. In this way, the pixel brightness is always equal to the average display brightness. This means that, per pixel, some (TFT) electronics is added to fulfill the following functions:
1. a data switch, for insertion of the data content into the pixel
2. a memory to store the content to at least the next row pulse, while in LCD the cell capacitance can be used
3. a pixel switch for connecting the pixel cell to the power supply: this switch might be combined with the input data switch.

U.S. Pat. No. 5,479,280 discloses an active matrix addressed liquid crystal display having two switching means and discharge means per pixel. The second switch is redundant, and has no first priority function, other than to increase processing yield. With this construction, however, capacitive crosstalk is injected, to compensate for the initial crosstalk of the first switch, while leakage is prevented with a series diode. Furthermore, this crosstalk is caused by row switching, while in the case of the invention the main function of the de-coupling diode means (transistor) is isolation during column activation.

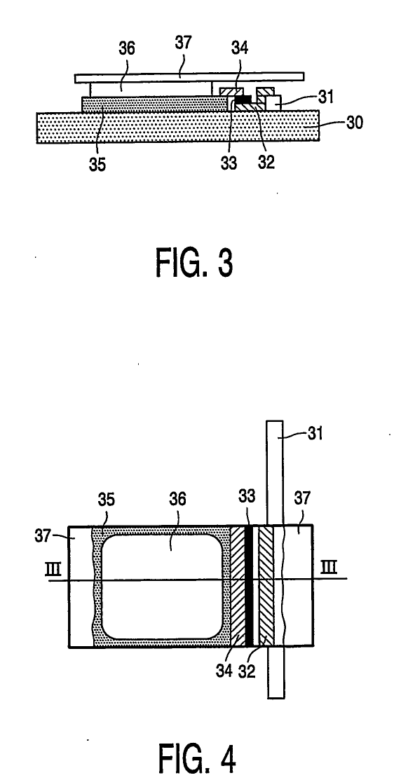

U.S. Pat. No. 4,651,149 discloses another active addressed liquid crystal display. In said display arrangement, an extra switch (31 in FIG. 3) is added, the main function of which is to perform adequate resetting of the pixel voltage while drawing a low DC current to prevent power dissipation. Furthermore, switch 31 is in parallel with the pixel (col. 3 line 14), while the invention proposes a switching action in series with the pixel.

Another difference between active and passive addressing is, that for passive addressing the light is generated during many short bright flashes during a frame time; this is done many times per second to avoid flicker effects. Furthermore, the switch function used in the invention is to prevent non-selected pixels from being charged from a basically reverse bias situation up to a basically zero bias situation (one could optionally go up to a low forward bias situation, as long as the material threshold voltage is not reached). This situation is different from the one described in U.S. Pat. No. 5,479,280, where a switch is needed to prevent a selected pixel from being discharged.

The objects and advantages of the invention will be set forth further in part in the description which follows, and in part will be obvious from the description, or may be learned by practice of the invention. The objects and advantages of the invention will be realized and attained by means of the elements and combinations particularly pointed out in the appended claims.

Some embodiments of the invention will be illustrated with reference to the drawings.

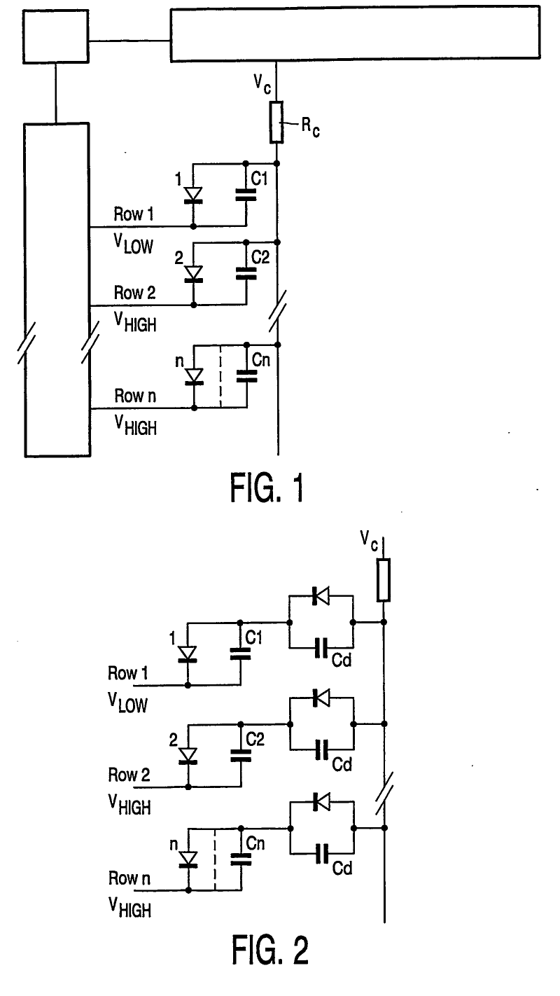

FIG. 1 is part of the circuitry for a convential passive addressed matrix display;

FIG. 2 is part of the circuitry for an embodiment of a passive addressed matrix display according to the invention;

FIG. 3. is a cross-section through a lateral pixel-diode arrangement (basic component) for a matrix display according to the invention;

FIG. 4 is a (plan) view of the basic component of FIG. 3;

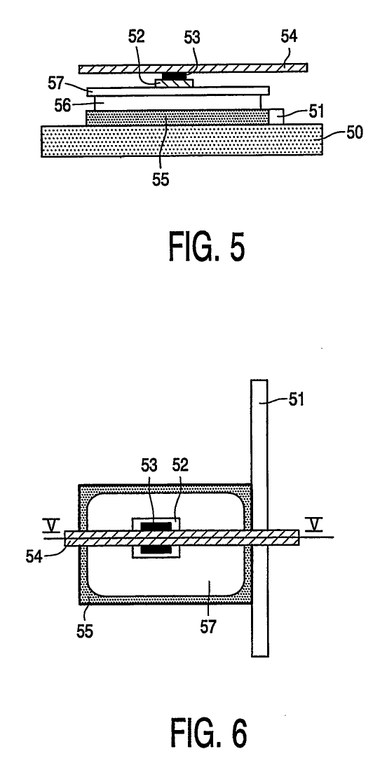

FIG. 5 is a cross-section through a vertical pixel-diode arrangement (basic component) for a matrix display according to the invention;

FIG. 6 is a (plan) view of the basic component of FIG. 5;

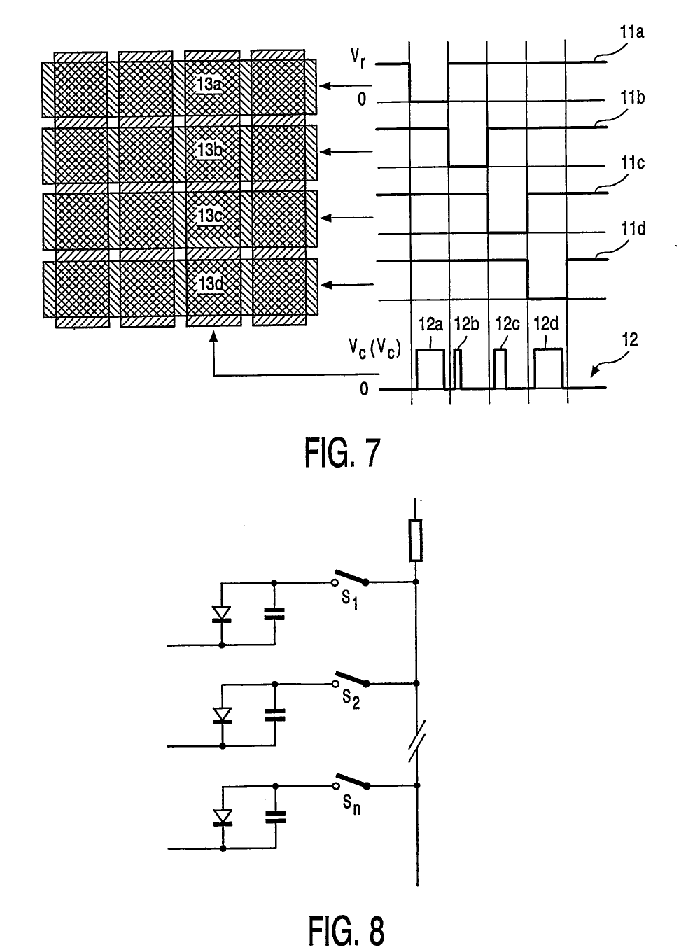

FIG. 7 is a diagram showing pulses for addressing a LED display unit, and

FIG. 8 schematically shows an embodiment of a matrix display according to the invention which uses active de-coupling means in the form of electromechanical switches.

FIG. 1 shows one column of a passive addressed matrix (PolyLED) display. Row 1 is selected by Vlow=0, while the other rows are unselected by Vhigh. To switch on pixel 1, the column voltage Vc has to rise from zero to the LED operating voltage Vp. During this transient, the reverse voltage across C2 . . . Cn decreases from Vhigh to Vhigh−Vp. To prevent these pixels from switching on, this voltage should not exceed the threshold voltage of 2V, a typical organic material value. The total charge stored in the column capacitors consists of C1×Vp (=charge in pixel 1) plus the charge (C2+ . . . +Cn)×Vp stored in the non-activated, mainly reverse-biased other 2 . . . n pixels. At the end of the light time, the column voltage is lowered back to zero and all charge is removed. For a switching frequency f (=n×frame rate) this causes a power dissipation of
Pc=f×n×Cp×Vp×Vp.

Although the charge can be removed via pixel 1 to generate light, or can be stored temporarily to be used during a subsequent charging up, the non-selected pixels 2 . . . n are charged and discharged without use. This leads to high peak currents during the column on switching transients and extra power loss. Another problem arises when so-called shorts are present in the display, indicated by the dashed short-circuit in pixel n. When this pixel is selected, the column current flows from the column line to the low row n voltage, and no light is generated, resulting in a black pixel. Much more annoying is the situation when one of the other rows is selected: the high row n voltage is forced on to the column line, and a selected pixel is always switched on, irrespective of the data input signal Vc at the external column node. In the Figure, Rc counts for the column resistance.

The problem is that unwanted current can flow on the non-selected reverse-biased pixels, leading to large charge storage and row-row current in case of pixel shorts. The invention solves the above problem by adding a de-coupling means, e.g. a diode or a switch, in series with every pixel, to prevent any unwanted charging/discharging. In a special case, it is avoided to allow a discharge current in the pixel diode reverse direction. Only the switch of the selected row pixel has to be turned on. In the driving scheme above, a simple diode will provide this function, as it automatically turns non-conductive in reverse bias. To reduce the stored charge as much as possible, this extra diode should have a small capacitance compared to the pixel capacitance, and a low on-voltage.

FIG. 2 schematically shows an embodiment where the de-coupling function is carried out with diodes. The diodes are arranged in such a way that they function as selective switches. The diode capacitance Cd now reduces the equivalent pixel capacitance from Cp to Ce=(Cp×Cd)/(Cp+Cd). The required voltage increases from Vp to Vp+Vd. This results in a total capacitive power dissipation of
P=f×n×Ce×(Vp+Vd)×(Vp+Vd)

For a good mono Si/Schottky type diode, both Cd and Vd are small compared to Cp and Vp resp. which reduces the power dissipation to
P=f×n×Cd×Vp×Vp

Power dissipation can thus be reduced by a factor Cd/Cp. Compared to a conventional active matrix addressed systems, some further advantages are:
no aperture loss caused by the pixel hold capacitor
no extreme low pixel current with their low values for current efficiency cd/A
no critical transistor matching requirements.

FIGS. 3 and 4 show a lateral pixel-diode arrangement. Arranged on a surface of substrate 30 (e.g. of Si) are:
a metal column electrode (anode) 31;
a first display electrode 32 (which in this case partially overlies column electrode 31);
a diode element 33;
a second display electrode 34 which connects the diode element 33 to an (ITO) electrode 35 (anode) of LED stack 36 (which stack 36 may comprise a polymer or an organic light emitting material layer);
a transparent row electrode (cathode) 37;
all as shown in a cross-section in FIG. 3.

A plan view of the resulting lateral pixel-diode arrangement is shown in FIG. 4.

FIGS. 5 and 6 show a vertical pixel-diode arrangement.

Arranged on a surface of substrate 50 (e.g. of Si) are:
a metal column electrode. (anode) 51;
a LED stack 56 (which may comprise e.g. a polymer or an organic light emitting material layer);
an (ITO) electrode 55 (anode of LED stack 56);
a metal row electrode 57 (cathode of LED stack 56);
a first display electrode 52 on top of the row electrode 57;
a diode element 53 sandwiched between the first display electrode 52 and a second display electrode 54;
all as shown in a cross-section in FIG. 5.

A plan view of the resulting vertical pixel-diode arrangement is shown in FIG. 6.

An example of a driving scheme is shown in FIG. 7. In this example, information is written line-at-a-time and the brightness is controlled by pulse-width modulation.

The voltages supplied to the four illustrated row electrodes are referred to as 11a-d. As is indicated by the division into time segments, the rows are placed at zero voltage potential one at a time. No modulation of these signals is necessary, as their only purpose is to “release” a particular row electrode at a certain time.

The voltage supplied to one of the four illustrated column electrodes is referred to as 12. As is indicated by the division into time segments, voltage pulses 12a-d of different width are fed to the electrode. The first pulse 12a will coincide with the signal 11a feeding a zero voltage to the upper row electrode, resulting in the LED 13a being activated. The second pulse 12b will similarly cause activation of the LED 12b, and so on. Since the brightness of the LED is primarily determined by the current, it is advisable to use current-driving instead of voltage-driving. Instead of using fixed-current/pulse-width-modulation, the brightness can also be controlled by using fixed-width/current-modulation (“amplitude” modulation). To obtain more grey scales, a combination of pulse-width modulation and pulse-height modulation can be used. The switching voltages for the row and columns may be of the order of 10 V. FIG. 8 schematically shows an embodiment in which electro-mechanical switches S₁, S₂ . . . Sₙ are used as de-coupling means.

It should be noted that many modifications of the above-described preferred embodiments can be realized by the skilled person. For example, other suitable materials can be used for the LED stack or the diodes. Also, the diodes can be arranged in a different way between the electrodes, as long as the intended function is achieved. Furthermore, the invention can be implemented, in principle, on any type of display based on the flow of current between two sets of electrodes, where it is desirable to achieve an improved addressing of the pixels.

In summary, the invention relates to a passive addressed matrix display having a plurality of luminescent picture elements. Driving circuitry having means for selecting rows of pixel elements and means for driving pixels in a row is provided. A de-coupling means is connected to each picture element for preventing said picture element from charging/decharging when it is in a non-select state and a simultaneously driven picture element is in a select state.

1. A passive addressed matrix display having a plurality of luminescent picture elements arranged in the matrix, a plurality of address buses arranged in rows of the matrix and supplied with a select signal having a low signal level and a high non-select signal level, and a plurality of data buses orthogonal to the address buses, each of said luminescent picture elements comprising a luminescent layer between a first and a second display electrode, characterized in that each luminescent picture element is combined with a de-coupling means connected between a respective one of the first and second display electrodes and a respective one of the address buses and the data buses, and in series with the picture element, for preventing said picture element from charging/discharging when it is in the non-select state and another picture element is in the select state.

2. A matrix display as claimed in claim 1, wherein said de-coupling means includes a diode.

3. A matrix display as claimed in claim 2, wherein said diode includes a Schottky diode.

4. A matrix display as claimed in claim 2, wherein each diode and the picture element with which it is combined form a lateral arrangement.

5. A matrix display as claimed in claim 2, wherein each diode and the picture element with which it is combined form a vertical arrangement.

6. A matrix display as claimed in claim 3, wherein the Schottky diode includes a layer stack comprising a metal layer and a layer of a semiconducting polymer material.

7. A matrix display as claimed in claim 6, wherein the picture elements comprise a luminescent layer of a semiconducting polymer material, said semiconducting polymer material having substantially the same composition as the semiconducting polymer material of the Schottky diode.

8. A matrix display as claimed in claim 1, wherein said de-coupling means includes an electromechanical switch.
